(19) United States
(12) Patent Application Publication
(10) Pub. No.: US 2022/0257352 A1
(43) Pub. Date: Aug. 18, 2022

(54) Dentoalveolar Trauma Stabilizer

(71) Applicant: The Medical College of Wisconsin, Inc., Milwaukee, WI (US)

(72) Inventors: David M. Poetker, Brookfield, WI (US); Jacob H. Bjork, Middleton, WI (US); Matthew D. Roggensack, Madison, WI (US)

(21) Appl. No.: 17/673,103

(22) Filed: Feb. 16, 2022

Related U.S. Application Data
(60) Provisional application No. 63/150,905, filed on Feb. 18, 2021.

(51) Int. Cl. A61C 9/00

(52) U.S. Cl. CPC A61C 9/0006; A61C 2201/00

(57) ABSTRACT

A dentoalveolar stabilizer includes a tray or channel having arranged thereon a stabilizing medium, which in some instances may be a wax-like medium. The tray and/or channel is sized and shaped to be placed over the entire mandibular (i.e., lower) or maxillary (i.e., upper) dentition. The stabilizing medium holds an affected tooth (e.g., a tooth that is loose or fractured following dentoalveolar trauma) in place and uses the stability of the adjacent healthy teeth and hard tissues to help stabilize the affected tooth. The dentoalveolar stabilizer can also stabilize an alveolar fracture, a palatal fracture, and/or a non-displaced mandible fracture. The dentoalveolar stabilizer can then be kept in place until the patient can be seen and definitively managed by a dental specialist.

### BACKGROUND

Dentoalveolar trauma is a common cause for presentation to an emergency department or urgent care clinic. It can be due to interpersonal violence or recreation activities such as skateboarding and contact sports. Despite the commonality of the trauma, it is poorly managed in the emergency or urgent care setting due to limited availability of a well-trained dental specialist. A dentist or oral surgeon can easily stabilize the loose or fractured tooth with a splinting technique. This technique, however, is time and labor intensive making it a poor option for the urgent care or emergency department provider.

### SUMMARY OF THE DISCLOSURE

The present disclosure addresses the aforementioned drawbacks by providing a dentoalveolar stabilizer that includes an arcuate outer side wall defining an outer periphery of the dentoalveolar stabilizer and a planar element spanning the outer side wall. The planar element defines a biting surface that is configured to receive at least one of upper teeth or lower teeth of a patient. A stabilizing medium is arranged on the biting surface, where the stabilizing medium has a consistency such that when an affected tooth is received by the stabilizing medium the affected tooth is held by the stabilizing medium and further stabilized by adjacent teeth also held by the stabilizing medium.

It is another aspect of the present disclosure to provide a dentoalveolar stabilizer kit that includes a dentoalveolar stabilizer, an insert, and a stabilizing medium. The dentoalveolar stabilizer includes an arcuate outer side wall defining an outer periphery of the dentoalveolar stabilizer and a planar element spanning the outer side wall and defining an upper surface. The insert has an upper surface and a lower surface, where the lower surface of the insert is sized and shaped to be received by the upper surface of the planar element and the upper surface of the insert defines a biting surface that is configured to receive at least one of upper teeth or lower teeth of a patient. The stabilizing medium is arranged on the upper surface of the insert. The stabilizing medium has a consistency such that when an affected tooth is received by the stabilizing medium the affected tooth is held by the stabilizing medium and further stabilized by adjacent teeth also held by the stabilizing medium.

It is still another aspect of the present disclosure to provide a dentoalveolar stabilizer that includes an upper dentition stabilizer, a lower dentition stabilizer, and a support member coupling the upper dentition stabilizer to the lower dentition stabilizer. The upper dentition stabilizer includes an arcuate outer side wall defining an outer periphery of the upper stabilizer; a planar element spanning the outer side wall and defining a biting surface that is configured to receive upper teeth of a patient; and a stabilizing medium arranged on the biting surface. The lower dentition stabilizer includes an arcuate outer side wall defining an outer periphery of the lower stabilizer; a planar element spanning the outer side wall and defining a biting surface that is configured to receive lower teeth of the patient; and a stabilizing medium arranged on the biting surface. The stabilizing medium has a consistency such that when an affected tooth is received by the stabilizing medium the affected tooth is held by the stabilizing medium and further stabilized by adjacent teeth also held by the stabilizing medium.

The foregoing and other aspects and advantages of the present disclosure will appear from the following description. In the description, reference is made to the accompanying drawings that form a part hereof, and in which there is shown by way of illustration a preferred embodiment. This embodiment does not necessarily represent the full scope of the invention, however, and reference is therefore made to the claims and herein for interpreting the scope of the invention.

### BRIEF DESCRIPTION OF THE DRAWINGS

FIG. 1 is an example dentoalveolar stabilizer having a tray according to some embodiments described in the present disclosure.

FIG. 2 is a top view of the dentoalveolar stabilizer of FIG. 1.

FIG. 3 is a back view of the dentoalveolar stabilizer of FIG. 1.

FIG. 4 is a top view of an example dentoalveolar stabilizer having a channel according to some embodiments described in the present disclosure.

FIG. 5 is a back view of the dentoalveolar stabilizer of FIG. 4.

FIG. 6 is a top view of an example dentoalveolar stabilizer having a channel and a removable palatal plate according to some embodiments described in the present disclosure.

FIG. 7 is a back view of the dentoalveolar stabilizer of FIG. 6.

FIG. 8 is an example dentoalveolar stabilizer having a tray and configured to receive an insert containing a stabilizer medium, in accordance with some embodiments described in the present disclosure.

FIG. 9 is an example dentoalveolar stabilizer having a channel and configured to receive an insert containing a stabilizer medium, in accordance with some embodiments described in the present disclosure.

FIG. 10 is an example dentoalveolar stabilizer that includes an upper dentition piece and a lower dentition piece coupled together via a support member.

### DETAILED DESCRIPTION

Described here is a dentoalveolar stabilizer that has advantageous use in the emergency department and/or urgent care setting. The dentoalveolar stabilizer described in the present disclosure provides a rapid, cost-effective way to stabilize a loose or fractured tooth, a fractured alveolus, a palatal fracture, and/or a non-displaced mandible fracture until the patient can be seen by a dental specialist.

In general, the dentoalveolar stabilizer described in the present disclosure includes a dental tray or channel having arranged thereon a stabilizing medium, which in some instances may be a wax-like medium. The tray and/or channel is sized and shaped to be placed over the entire mandibular (i.e., lower) or maxillary (i.e., upper) dentition, depending on the location of the affected tooth. The stabilizing medium holds the affected tooth in place and uses the stability of the healthy teeth, as well as hard tissues that are adjacent and/or remote to the affected tooth, to help stabilize the affected tooth. The dentoalveolar stabilizer can then be kept in place until the patient can be seen and definitively managed by a dental specialist.

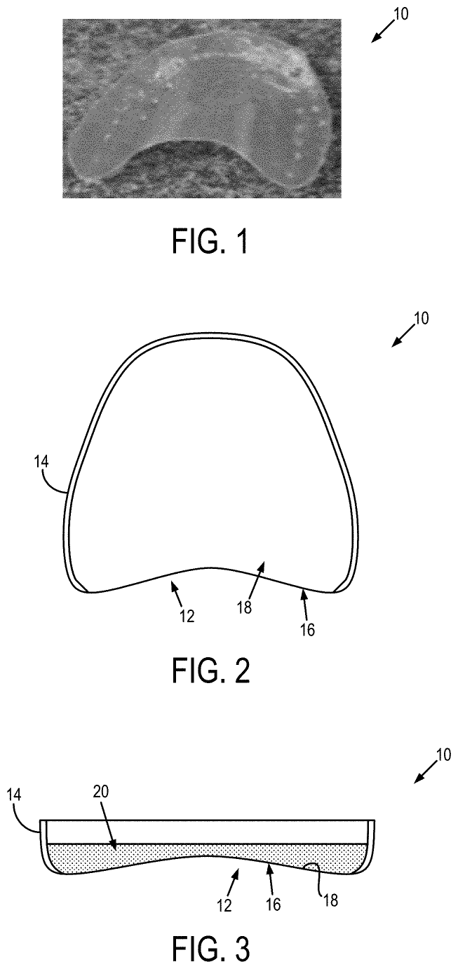

Referring now to FIGS. 1-3, an example dentoalveolar stabilizer 10 in accordance with some embodiments described in the present disclosure is shown. The dentoalveolar stabilizer 10 generally includes a tray 12 that is defined by an arcuate outer side wall 14 and a planar element 16 that forms a biting surface 18 of the dentoalveolar stabilizer 10.

The planar elementl6 spans the arcuate outer side wall 14 from one side of the dentoalveolar stabilizer 10 to the other. In some embodiments, the planar element 16 is a curved planar element that conforms to the roof of the patient's mouth, or is otherwise generally contoured to follow the shape of the roof of the patient's mouth.

The biting surface 18 is generally sized and shaped to conform to or otherwise receive the upper teeth (i.e., the maxillary dentition) of the patient and/or the lower teeth (i.e., the mandibular dentition) of the patient.

A stabilizing medium 20 is arranged on the biting surface 18 of the planar element 16. The stabilizing medium 20 has a consistency such that when the dentoalveolar stabilizer 10 is positioned within the patient's mouth and the patient bites down on the dentoalveolar stabilizer 10, the affected tooth is received by the stabilizing medium 20 and held in place by the stabilizing medium 20 and further stabilized by the adjacent teeth also being received by the stabilizing medium 20. Further, hard tissues that are adjacent and/or remote to the affected tooth can also provide stability. Additionally or alternatively, when the dental trauma does not result in a loosened or fractured tooth, but instead results in an alveolar fracture, a palatal fracture, and/or a non-displaced mandible fracture, the healthy teeth are received by the stabilizing medium 20, which in turn provide support to the affected portion of the patient's dental anatomy.

In one example, the stabilizing medium has a generally wax-like consistency, such that the affected tooth can be received and held by the stabilizing medium 20. As one non-limiting example, the stabilizing medium 20 can be composed of paraffin wax, soy wax, palm wax, microcrystalline wax, carnauba wax, bees wax, bone wax, carding wax, or other waxes, including other dental waxes and/or medical waxes. Additionally or alternatively, the stabilizing medium 20 can be composed of materials such as dental impression materials, alginate, alginate substitute, or isopropyl palmitate.

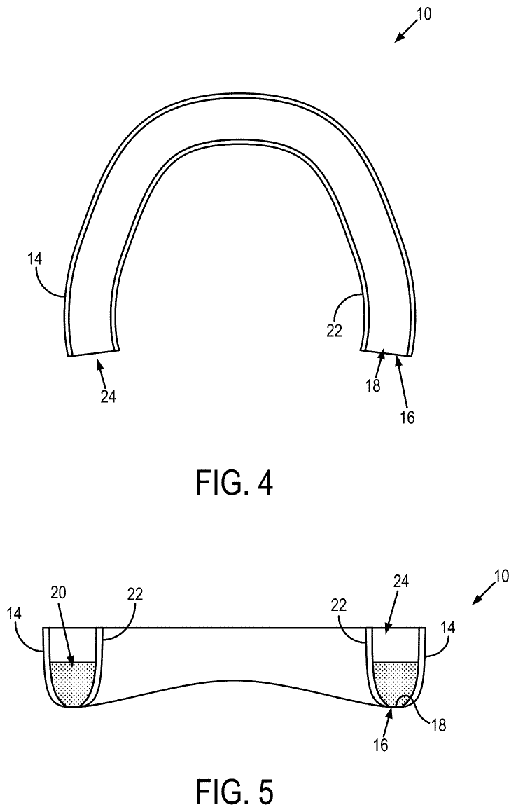

Referring now to FIGS. 4 and 5, in some other embodiments, the dentoalveolar stabilizer 10 can further include an arcuate inner side wall 22, such that the dentoalveolar stabilizer 10 is generally U-shaped. In these embodiments, the planar element 16 spans the distance between the arcuate outer side wall 14 and the arcuate inner side wall 22, thereby defining a channel 24. The channel 24 is sized and shaped to conform to or otherwise receive the upper teeth (i.e., the maxillary dentition) of the patient and/or the lower teeth (i.e., the mandibular dentition) of the patient. The stabilizing medium 20 is arranged within the channel 24.

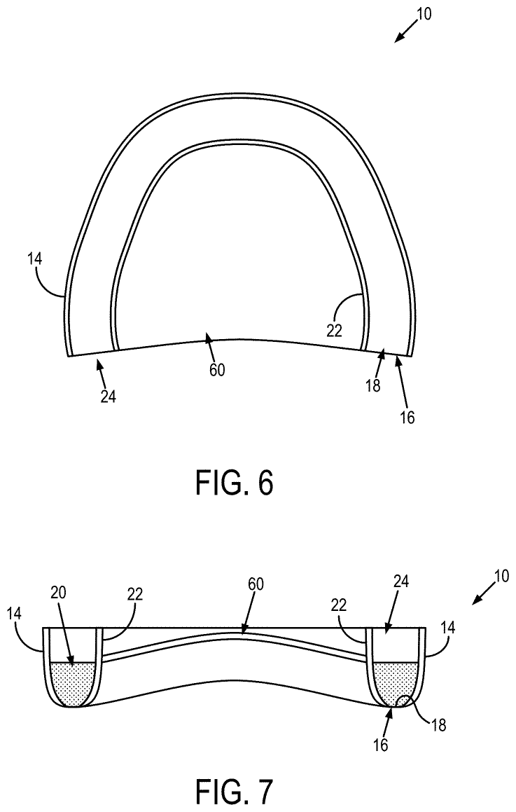

In some configurations, such as those shown in FIGS. 6 and 7, the dentoalveolar stabilizer 10 can be constructed as shown in FIGS. 4 and 5 while further including a palatal plate 60 that spans the space between the arcuate inner side wall 22. The palatal plate can be removable, such that a single dentoalveolar stabilizer 10 design can be modified to accommodate both the upper dentition (e.g., with the palatal plate 60 in place) and the lower dentition (e.g., with the palatal plate 60 removed to accommodate the tongue). The palatal plate 60 can be removably coupled to the arcuate inner side wall 22 via perforations or the like.

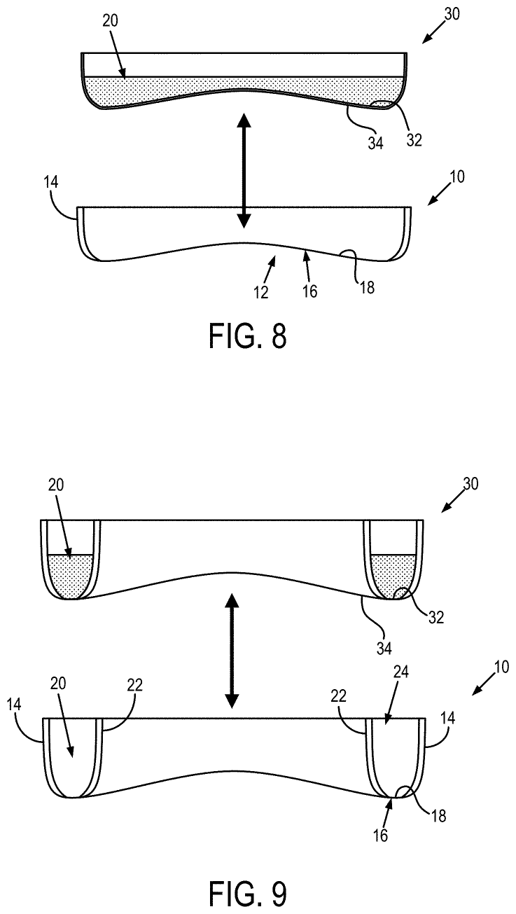

In the embodiments described above, the stabilizing medium 20 is arranged on the biting surface 18 of the tray 12 and/or channel 24. In some other embodiments, such as those shown in FIGS. 8 and 9, the dentoalveolar stabilizer 10 can include a separate insert 30 containing the stabilizing medium 20. The insert 30 has an upper surface 32 and a lower surface 34, and is sized and shaped to be received by the biting surface 18 of the dentoalveolar stabilizer 10 by placing the lower surface 34 of the insert 30 into contact with the biting surface 18 of the dentoalveolar stabilizer 10. The stabilizing medium 20 is arranged on the upper surface 32 of the insert 30. In these configurations, the dentoalveolar stabilizer 10 may be a sterilizable, multi-use dentoalveolar stabilizer 10, and the insert 30 can be a single-use disposable insert 30.

The insert 30 can be adhered or otherwise coupled to the biting surface 18 of the planar element 16, which may also be referred to as the upper surface of the planar element 16. As one non-limiting example, the insert 30 can be adhered to the upper surface of the planar element 16 using a medical-grade adhesive, or the like.

In some embodiments, the dentoalveolar stabilizer 10 and/or insert 30 can be composed of a durable material, such as a hard acrylic material. In some instances, the dentoalveolar stabilizer 10 and/or insert 30 can be manufactured using additive manufacturing techniques, such as 3D printing. In these instances, the dentoalveolar stabilizer 10 and/or insert 30 can be composed of suitable build materials, such as acrylonitrile butadiene styrene (“ABS”). Additionally or alternatively, the dentoalveolar stabilizer 10 and/or insert 30 can be composed of various plastics and/or rubber, including but not limited to a thermoplastic material, a polyethylene material, polyvinyl chloride, extruded plastic materials, polypropylene, polystyrene, extruded polystyrene (e.g., Styrofoam™), vinyl, and so on.

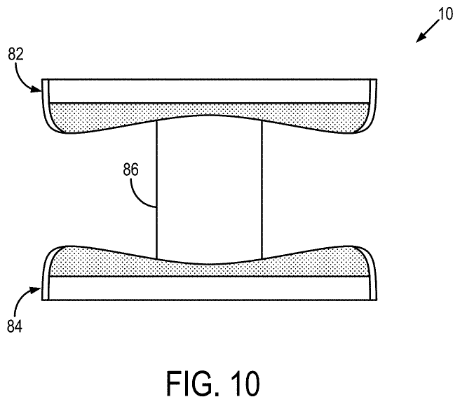

As shown in FIG. 10, in some embodiments the dentoalveolar stabilizer 10 can include an upper stabilizer 82 and a lower stabilizer 84, which are coupled together by a support member 86. Advantageously, this design enables to dentoalveolar stabilizer 10 to receive both the upper dentition and the lower dentition. This can be beneficial for patients who may not have sufficient dentition surrounding the affect tooth in order to stabilize the affected tooth. For example, if the affected tooth is in the upper dentition, but the upper dentition does not have a sufficient number of teeth adjacent the affected tooth, then by using a dentoalveolar stabilizer 10 such as the one shown in FIG. 8, the teeth in the lower dentition can be used to provide additional support of the affected tooth. The support member 86 can span a portion of the arcuate periphery of the dentoalveolar stabilizer 10, as shown in FIG. 10, or can span the entire arcuate periphery of the dentoalveolar stabilizer 10.

In some embodiments, the dentoalveolar stabilizer 10 can also be configured to include airways (e.g., holes, channels) that enable the patient to breathe through the dentoalveolar stabilizer 10.

When a patient who has suffered a dentoalveolar trauma that results in one or more teeth being loosened, fractured, or both; the bony alveolus being fractured; a palatal fracture; and/or a non-displaced mandible fracture, the dentoalveolar stabilizer described in the present disclosure can be used to stabilize the affected anatomy until a dental specialist is able to treat the patient. The dentoalveolar stabilizer is first prepared for use. This can include depositing or otherwise arranging a stabilizing medium on the biting surface of the dentoalveolar stabilizer, or adhering, or otherwise coupling, an insert already containing stabilizing medium to the dentoalveolar stabilizer. The prepared dentoalveolar stabilizer is then positioned within the patient's mouth. When the dentoalveolar stabilizer has been properly positioned, the patient is instructed to bite down on the dentoalveolar stabilizer. Because the stabilizing medium has a pliable, yet stable, consistency, the affected tooth is able to be received within the stabilizing medium without aggravating or otherwise worsening the condition of the affected tooth. The stabilizing medium then holds the affected tooth in place until the patient can be seen by a dental specialist. Furthermore, by having the adjacent, healthy teeth also received into the stabilizing medium, these adjacent teeth are able to further stabilize the affected tooth. Likewise, hard tissues that are adjacent and/or remote to the affected tooth, or other affected dental anatomy, can also provide support when the dentoalveolar stabilizer is positioned within the patient's mouth.

In this way, the dentoalveolar stabilizer enables the patient to be treated in the emergency department or urgent care clinic setting while greatly reducing the risk of additional trauma to the affected tooth. Then, after the patient has been treated in the emergency department or urgent care clinic setting, the patient can be seen by a dental specialist, who will remove the dentoalveolar stabilizer to gain access to the affected tooth.

The present disclosure has described one or more preferred embodiments, and it should be appreciated that many equivalents, alternatives, variations, and modifications, aside from those expressly stated, are possible and within the scope of the invention.

1. A dentoalveolar stabilizer, comprising:
an arcuate outer side wall defining an outer periphery of the dentoalveolar stabilizer;
a planar element spanning the outer side wall and defining a biting surface that is configured to receive at least one of upper teeth or lower teeth of a patient; and
a stabilizing medium arranged on the biting surface, wherein the stabilizing medium has a consistency such that when an affected tooth is received by the stabilizing medium the affected tooth is held by the stabilizing medium and further stabilized by adjacent teeth also held by the stabilizing medium.

2. The dentoalveolar stabilizer of claim 1, wherein the planar element is a curved planar element that is shaped to conform to a roof of a patient's mouth.

3. The dentoalveolar stabilizer of claim 1, further comprising an arcuate inner side wall defining an inner periphery of the dentoalveolar stabilizer, wherein the planar element extends from the outer side wall to the inner side wall to define a channel that is configured to receive at least one of the upper teeth or the lower teeth of the patient.

4. The dentoalveolar stabilizer of claim 3, further comprising a palatal plate removably coupled to the inner side wall.

5. The dentoalveolar stabilizer of claim 4, wherein the palatal plate is removably coupled to the inner side wall via perforations.

6. The dentoalveolar stabilizer of claim 1, wherein the stabilizing medium is composed of a wax.

7. The dentoalveolar stabilizer of claim 6, wherein the wax is at least one of paraffin wax, soy wax, palm wax, microcrystalline wax, carnauba wax, bees wax, bone wax, or carding wax.

8. The dentoalveolar stabilizer of claim 1, wherein the stabilizing medium is composed of a dental impression material.

9. The dentoalveolar stabilizer of claim 8, wherein the dental impression material is at least one of alginate or alginate substitute.

10. A dentoalveolar stabilizer kit, comprising:
a dentoalveolar stabilizer comprising:
an arcuate outer side wall defining an outer periphery of the dentoalveolar stabilizer;
a planar element spanning the outer side wall and defining an upper surface;
an insert having an upper surface and a lower surface, wherein the lower surface of the insert is sized and shaped to be received by the upper surface of the planar element and the upper surface of the insert defines a biting surface that is configured to receive at least one of upper teeth or lower teeth of a patient; and
a stabilizing medium arranged on the upper surface of the insert, wherein the stabilizing medium has a consistency such that when an affected tooth is received by the stabilizing medium the affected tooth is held by the stabilizing medium and further stabilized by adjacent teeth also held by the stabilizing medium.

11. The dentoalveolar stabilizer kit of claim 10, wherein the planar element is a curved planar element that is shaped to conform to a roof of a patient's mouth.

12. The dentoalveolar stabilizer kit of claim 11, wherein the insert is shaped to conform to the upper surface of the planar element.

13. The dentoalveolar stabilizer kit of claim 10, further comprising an arcuate inner side wall defining an inner periphery of the dentoalveolar stabilizer, wherein the planar element extends from the outer side wall to the inner side wall to define a channel that is configured to receive the insert.

14. The dentoalveolar stabilizer kit of claim 10, wherein the stabilizing medium is composed of a wax.

15. The dentoalveolar stabilizer kit of claim 14, wherein the wax is at least one of paraffin wax, soy wax, palm wax, microcrystalline wax, carnauba wax, bees wax, bone wax, or carding wax.

16. The dentoalveolar stabilizer of claim 10, wherein the stabilizing medium is composed of a dental impression material.

17. The dentoalveolar stabilizer of claim 16, wherein the dental impression material is at least one of alginate or alginate substitute.

18. A dentoalveolar stabilizer, comprising:
an upper dentition stabilizer comprising:
an arcuate outer side wall defining an outer periphery of the upper stabilizer;
a planar element spanning the outer side wall and defining a biting surface that is configured to receive upper teeth of a patient;
a stabilizing medium arranged on the biting surface;
a lower dentition stabilizer comprising:
an arcuate outer side wall defining an outer periphery of the lower stabilizer;
a planar element spanning the outer side wall and defining a biting surface that is configured to receive lower teeth of the patient;
a stabilizing medium arranged on the biting surface; and
a support member coupling the upper dentition stabilizer to the lower dentition stabilizer;
wherein the stabilizing medium has a consistency such that when an affected tooth is received by the stabilizing medium the affected tooth is held by the stabilizing medium and further stabilized by adjacent teeth also held by the stabilizing medium.

19. The dentoalveolar stabilizer of claim 18, wherein the stabilizing medium is composed of a wax.

20. The dentoalveolar stabilizer of claim 18, wherein the stabilizing medium is composed of a dental impression material.
